(19) United States
(12) Patent Application Publication
(10) Pub. No.: US 2009/0271144 A1
(43) Pub. Date: Oct. 29, 2009

(54) DETECTION UNIT PROTECTED AGAINST DETACHMENT AND/OR FORCED ENTRY AND SYSTEM THAT COMPRISES AT LEAST ONE SUCH UNIT

(75) Inventor: Jean-Michel REIBEL, Lampertheim (FR)

Correspondence Address: YOUNG & THOMPSON, 209 Madison Street, Suite 500, ALEXANDRIA, VA, 22314, US

(73) Assignee: RADIO SYSTEMES INGENIERIE VIDEO TECHNOLOGIES (SA), Strasbourg (FR)

(21) Appl. No.: 12/432,047

(22) Filed: Apr. 29, 2009

(30) Foreign Application Priority Data
Apr. 29, 2008 (FR) 08 52867
Jul. 11, 2008 (FR) 08 54735

(51) Int. Cl. G06F 15/00; G01C 9/00

(52) U.S. Cl. 702/154; 702/150

(57) ABSTRACT

A detection unit integrates at least one motion detector, a presence detector, a camera, or a combination of at least two such devices, in particular as a component of a security, alarm and/or surveillance system, whereby the functional elements of the unit are housed in a housing that is attached to a wall, a pole, a roof or the like, via an attachment accessory, in particular of the articulated arm type or the like. The unit also includes an element (5) that can measure a variation of the absolute angle relative to the vertical line of a reference surface of the housing (2), a portion of the housing (2), at least one internal functional element, or a group of such internal functional elements (3), and can deliver a measuring signal that can be exploited by the unit (1) and/or the system to which the unit (1) belongs.

This invention has as its object a detection unit that integrates at least one motion detector, a presence detector, a camera, or a combination of at least two such devices, in particular as a component of a security, alarm and/or surveillance system, whereby the functional elements of said unit are housed in a housing that is attached to a wall, a pole, a roof or the like, in particular by means of an attachment accessory, in particular of the articulated arm type or the like.

Unit (1) characterized in that it also comprises a means (5) that can measure a variation of the absolute angle relative to the vertical line of a reference surface of the housing (2), a portion of the housing (2), at least one internal functional element, or a group of such internal functional elements (3), and that can deliver a measuring signal that can be exploited by the unit (1) and/or the system to which said unit (1) belongs.

### FIELD OF THE INVENTION

This invention relates to the field of security, alarm and/or surveillance systems and has as its object a detection unit that is protected against detachment and/or forced entry and a system of the above-mentioned type that comprises at least one such unit.

### BACKGROUND OF THE INVENTION

The detectors that are currently used in the security, surveillance or alarm systems are generally protected against detachment (from the wall support) and/or against the opening of the housing that contains them.

In these known products, in the nominal state (attached and closed product), one or more protection contacts are kept activated. If an opening or a detachment takes place, corresponding contacts cause a signal to be sent to the central unit of the system (signal that can be a loop break on a cable system or the transmission of a radio message in a wireless system).

Among the detectors that are currently known, there are in particular combinations of motion or presence detector/video camera, CCD or the like, that film the protected zone only in the case of detection by the detector.

FIGS. 1 to 3 are respectively side, rear and cutaway views of a detector of the above-mentioned type, which comprises a cover or a rear-face housing part that allows the wall attachment.

This cover or this rear part has attachment holes, allowing attachment at an angle or on a flat surface.

In one known embodiment, holes that correspond to the attachment at an angle and to the attachment when flat are made in a weakened zone of the rear cover. On its inside face, this weakened zone comprises a projection that rests against a contact that therefore remains activated while the housing remains closed and the detector remains attached to the wall.

In this way, a detachment of the detector will cause the breaking of the weakened zone that will remain attached to the wall. In the same way, an opening of the housing will lead to the release and the deactivation of the contact.

In a variation of these detectors designed for outside use, the additional problem that is linked to attachment accessories arises.

Actually, the outside camera-type detectors are often attached at the end of an arm via a ball joint that allows the pointing of the camera (and, in the above-mentioned case, of the associated motion detector), so as to be able to specifically regulate the zone to be monitored.

In this type of installation, the detector unit or the camera is no longer closely connected to the wall support (or its equivalent, such as a pole, for example).

Whereby the detachment can then no longer be carried out at the level of the camera but at the attachment of the arm on the wall, it is no longer detectable except in using complex solutions to be implemented.

In addition, a misalignment (whether it is accidental or malicious) at the ball joint, or an unscrewing of the attachment plate of the arm is no longer detected or indicated.

This invention has as its object to overcome the above-mentioned limitation in a simple way, by preferably making it unnecessary to use any direct or physical connection between the support and the detector.

### SUMMARY OF THE INVENTION

For this purpose, the invention has as its object a detection unit that integrates at least one motion detector, a presence detector, a camera, or a combination of at least two such devices, in particular as a component of a security, alarm and/or surveillance system, whereby the functional elements of said unit are housed in a housing that is attached to a wall, a pole, a roof or the like, in particular by means of an attachment accessory, in particular of the articulated arm type or the like, a unit that is characterized in that it also comprises:
A means that can measure a variation of the absolute angle relative to the vertical line of a reference surface of the housing, a portion of the housing, at least one internal functional element, or a group of such internal functional elements, and that can deliver a measuring signal that can be exploited by the unit and/or the system to which said unit belongs,
A means for storing an angular reference position relative to the vertical line, for example acquired during the installation of the unit, and
A means for comparing the difference between the value that is measured by the means and this reference value, with a threshold value for triggering the signaling to the system.

### BRIEF DESCRIPTION OF THE DRAWINGS

The invention will be better understood using the description below, which relates to a preferred embodiment, provided by way of nonlimiting example and explained with reference to the accompanying diagrammatic drawings, in which:

FIGS. 1 to 3 are respectively side, rear and cutaway views of a known detector, and

FIGS. 4 and 5 are diagrammatic representations, transversal cutaway views or transparency views of a detection unit according to two embodiments of the invention.

### DETAILED DESCRIPTION OF THE INVENTION

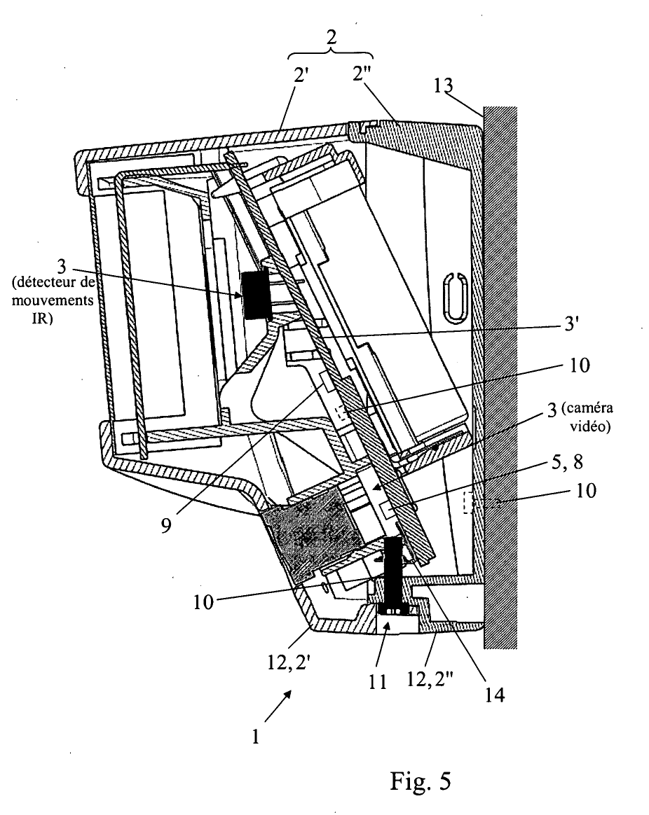

FIGS. 4 and 5 show a detection unit 1 that integrates at least one motion detector, one presence detector, a camera or a combination of at least two such devices, in particular as a component of a security, alarm and/or surveillance system, whereby the functional elements 3 of said unit 1 are housed in a housing 2 that is attached to a wall (FIG. 5), a pole, a roof or the like, in particular by means of an attachment accessory 4, in particular the articulated arm type or the like (support arm with a ball joint, for example, as FIG. 4 shows).

According to the invention, the detection unit 1 also comprises a means 5 that can measure a variation of the absolute angle relative to the vertical line of a reference surface of the housing 2, a portion of the housing 2, at least one internal functional element or a group of such internal functional elements 3, and that can deliver a measuring signal that can be exploited by the unit 1 and/or the system to which said unit 1 belongs, a means for storing an angular position for reference relative to the vertical line, for example obtained during the installation of the unit 1 (whereby any incline relative to the vertical line is possible), and a means of comparison of the difference between the value measured by the means 5 and this reference value, with a threshold value for triggering the signaling to the system.

Thus, the invention makes it possible in a simple manner to reach the above-mentioned object without involving a noteworthy structural modification.

Consequently, whereby the detection unit 1 was originally installed with an initial or reference orientation or pointing, any manipulation of said unit 1 that brings about a change (unwanted) in orientation of the means 5 beyond a preset threshold value causes the generation of an alarm or a warning that informs the central unit of an attempt to neutralize or damage unit 1, in particular a voluntary or accidental displacement of the latter.

The storage means and the comparison means can be provided by, for example, an integrated circuit 8 such as a microprocessor with memory or a microcontroller, mounted in the housing 2 and being part of the group of functional elements 3 of the unit 1.

The above-mentioned comparison means can come in the form of a material circuit or be provided in the form of a software function that is achieved by the integrated circuit 8.

The means 5 can provide a measurement of the absolute value of the orientation (and therefore of its variation) directly from the difference between the reference and the current position to the integrated circuit 8.

If necessary, the measuring means 5 can also be integrated into the integrated circuit 8 (see FIG. 5) by thus forming a dedicated hybrid circuit 5, 8.

The measuring signal that is provided by the means 5 can be exploited by the unit 1 itself, which will then transmit, if necessary, an alarm signal to the central unit of the system, or be transmitted (as is or after preprocessing) to the latter for its exploitation.

In the first case corresponding to the invention and in a practical manner, the unit 1 stores an angular position following the installation and compares the following measurements to this reference value. A threshold corresponding to the maximum deviation tolerated will determine at what time the signaling is actually triggered.

In accordance with a preferred embodiment of the invention, the means 5 that can measure a variation of the absolute angle relative to the vertical line comprises or consists of an inclinometer that is associated with a reference surface that is part of the unit 1, the housing 2 or a functional element 3 that is part of the device—or of one of the devices—of the detector or camera type.

For the purpose of also making possible the detection of a possible unauthorized opening of the housing 2, the means 5 is advantageously mounted on a portion of the housing 2 or on a support of a group of functional elements 3, such as an electronic card 3′, necessarily undergoing, in the case of the housing 2 being opened, a displacement or a movement generating a modification of its angular orientation, in particular a movement of rotation or pivoting.

The implementation of this characteristic requires a suitable design of the housing 2 such that its opening requires or entrains a rotation of the electromagnetic part of the unit 1 that will be detected by the means 5.

According to a first embodiment of the invention, the inclinometer-type means 5 consists of an integrated circuit that integrates an electronic device for conditioning the signal delivered by a sensitive element in the form of a microsystem that is manufactured on silicon and consists of a capacitive comb that deforms under the action of gravity.

According to a second embodiment of the invention, the inclinometer-type means 5 consists in an accelerometer with two axes, in particular of the MEMS type.

Advantageously, the inclinometer 5 of the accelerometer type with two axes provides a measuring signal with a continuous component that corresponds to the earth's gravity and an alternative component that makes it possible, when its value exceeds a predetermined threshold, to detect vibrations and/or sudden displacements from the reference surface associated with said inclinometer 5.

Such an implementation of the inclinometer authorizes a more universal detection of the handling of the unit 1 in question.

The sign of the signal provided by the accelerometer can be exploited by, for example, the microprocessor 8 to determine whether the camera that forms the unit 1 (FIG. 4) or that is integrated in the unit 1 (FIG. 5) is arranged “head at the top” (as in FIG. 4) or “head at the bottom” (suspended camera). This function makes it possible, if necessary, to reestablish an image at the location by providing a reversed output signal or “mirror” signal.

It should be noted that the unit 1 can comprise, in addition to the inclinometer 5, one or more other means of protection or security as indicated below.

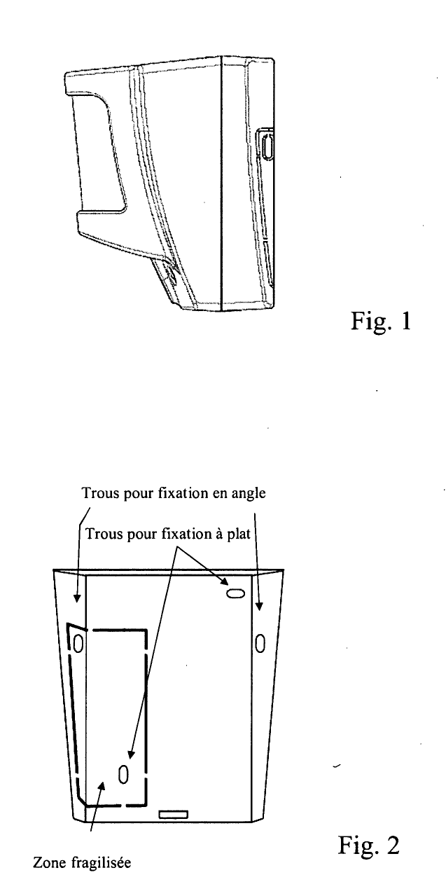

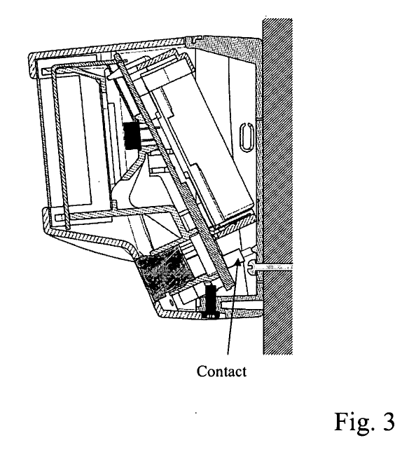

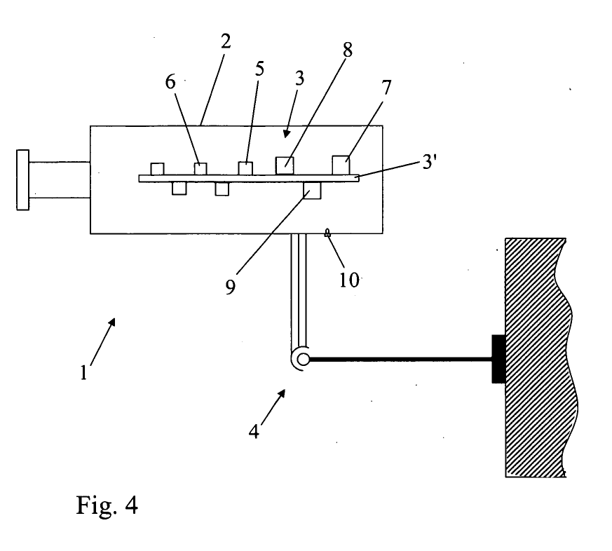

The inclinometer 5 in the form of an integrated circuit can be mounted as an additional component on the printed circuit card that bears the components that implement the other functions of the detection unit 1. The latter can then have both an embodiment as shown in FIGS. 1 to 3 (with the pre-cut zones or weakened lines at least, as well as optionally the contact) as well as an embodiment such as the one that is evident from FIG. 4 (mounting on an articulated arm).

In accordance with an additional characteristic of the invention, unit 1 can also comprise a sensor 6 that makes it possible to determine the orientation of the earth's magnetic field and able to provide an indication on the orientation of a device for detection or guided visualization of said unit 1 or of the latter itself, whereby said sensor 6 optionally can consist of a magnetoresistive sensor.

So as to allow the detection of a change in height of unit 1 without modification of the vertical angle or the orientation of the latter (for example, sliding the unit 1 along a smooth pole), a variant embodiment of the invention provides that the unit 1 also comprises a means 7 for determining the height of said unit 1 relative to the ground or to a reference surface, for example in the form of an ultrasonic sensor, a pressure sensor, or the like (for example, a GPS device).

Another variant embodiment can provide for detecting the change in height by using the alternate component of the measuring signal that is provided by the inclinometer 5 of the accelerometer type that is mentioned above.

Advantageously, the angular measurement is carried out intermittently to reduce the electrical consumption of the system and in particular of the unit 1, in particular when the latter operates autonomously using cells or batteries. In this case, the means 5 is activated intermittently.

This invention also proposes, in particular in relation to the embodiment that is shown in FIG. 5, to reinforce the protection of a unit as mentioned above against the detachment (in particular in the case of attachment to a wall 13 or an analogous support) and/or again the unauthorized opening of the housing 2, for example by disengaging the constituent parts 2′ and 2″ from the latter.

For this purpose, it may be provided that the unit 1 also comprises, among its functional elements 3, at least one means 9 that can measure a variation of capacity between at least two parts that form electrodes 10 or between at least one electrode-forming part 10 and a virtual or real mass of said unit 1, whereby said electrode(s) 10 is/are located on or inside the housing 2 by a mounting point that is protected from the unplanned or accidental approach of an object, element, body or the like that can influence or modify a charge or an electrical field, whereby said means 10 delivers a measuring signal, a passing signal or an incident signal that can be exploited by the unit 1 and/or by the system to which said unit 1 belongs and that forms—in association with said at least one electrode 10—a capacitive-type proximity detector.

According to the sensitivity of the unit [electrodes 10/measuring means 9], the triggering of a warning indicating an incident interfering with the security of the unit 1 can take place either at the time of contact with the electrode or one of the electrode(s) 10, or already in an approach phase of this electrode 10, before any physical contact with the latter.

The triggering of the warning also takes place, of course, in the event of the link or the electrical connection between the electrode(s) 10 and the means 9 being broken.

The type of signal delivered by the means 9 (measuring signal, passing signal, warning signal) will be a function of the mode of operation of the system to which said unit 1 belongs, of the sophistication of the means 9 (analog or digital circuit), of the type of link existing between the unit 1 in question and the central unit of the system, and the type of supply of said unit 1, which processes its activity and its energy autonomy.

The means 9 can consist of either a simple measuring circuit, or a circuit for measurement and evaluation.

By way of practical, nonlimiting embodiments, the means 9, combined with said at least one electrode 10 for forming a proximity detector, is selected from the group that is formed by the detector circuits with a time constant RC, with phase shift, with frequency modulation and with amplitude modulation. Such capacitive-type proximity detectors are known in particular from the Freescale Semiconductors Company (filed name).

As indicated above, the means 9 can either come in the form of a circuit that is independently mounted on a card or a printed circuit 3′, or optionally can be integrated in a hybrid circuit that also incorporates the microprocessor 8 and the inclinometer 5.

In accordance with a very advantageous variant embodiment of the invention, illustrated in FIG. 5 of the drawings, one of or said at least one electrode(s) 10 consists of a conductive assembly part or an attachment part of the protective housing 3, preferably a metal part, such as, for example, a screw or the like.

FIG. 5 simultaneously illustrates an assembly screw and (in dotted lines) an attachment screw, each able to form an electrode 10.

Within the framework of the above-mentioned variant, it can be provided that the assembly part or each assembly part or removable attachment part 10 that forms an electrode is mounted in a nut 14, a threaded sleeve or an analogous mounting site that is connected electrically to measuring means 9, whereby the connection between said electrode 10 and said measuring means 9 is established only after complete or definite mounting of the corresponding part 10.

The nut 14 can come, for example as FIG. 5 shows, in the form of a nut made of folded sheet metal that is integral with the printed circuit (welded or set) and that is directly connected electrically to an input of measuring means 9.

Thus, it is also possible to use the proximity detector that is formed by 9 and 10 to monitor the correct assembly of the various parts 2′, 2″ of the protective housing 2.

For the purpose of preventing an ill-timed triggering of the warning of a forced entry or a detachment, not linked to a voluntary action, said at least one electrode 10 is mounted on a support or an analogous retractable deformation 11 of the protective housing 2.

Advantageously, the electrode or each electrode 10, in the form of an assembly means or attachment means, is housed at the bottom of a deformation 11 in the form of a well of a constituent part 2′, 2″ of the protective housing 2.

According to an alternative or additional variant embodiment for at least one electrode 10, it can also be provided that one of the electrodes or said at least one electrode 10 is located at a mounting point in the protective housing 2 that is far from the wall 12 of the latter, in particular accessible and apparent wall portions in the installed state of said unit 1 (see electrode 10 that is shown in broken lines on the printed circuit 3′ of FIG. 5).

In accordance with another alternative or additional variant embodiment, it can be provided that the electrode 10 or at least one electrode 10 consists of a means for detecting the presence of the end of an assembly screw, whereby this means comes in the form of a belt or a strip portion of the printed circuit 3′ that bears the functional elements or components 3 of said unit 1, connected to the means 9.

By way of practical embodiment, the zone of the printed circuit 3′ that accommodates the screw 14 can be surrounded by a strip that is located at a small distance and that is connected to the input for the measuring of means 2.

The first variant described above (screw 10 forming a directly connected electrode) delivers a very high level of signal, but it is able to increase the capacity of the electronic device, in particular in the event of electrostatic discharge, contrary to the last variant above in which the strip that surrounds the nut 14 forms a condenser with the nut. Of course, the signal level finds itself greatly reduced, but the risk of electrostatic discharge is also greatly reduced. The selection of one or the other variant may depend on the final use (and the associated environment).

Thus, thanks to the invention, it is possible to determine and to point out various types of possible neutralizations of a detection unit 5.

It is also possible to determine a possible movement or displacement of the unit 5 that does not necessarily follow a voluntary action.

Thus, when the ball joint that is used for regulating the pointing of unit 1 is inadequately locked, its orientation can be upset without a malicious action. This can occur under the weight of snow accumulated on the housing 2 or when a bird rests on the latter. The improper operation is then detected by the change in vertical angle.

In addition, the additional characteristics of the invention make it possible to ensure a reinforced protection of the unit 1 against the detachment and/or against an unauthorized opening of its protective housing 2.

This invention also has as its object a security, alarm and/or surveillance system that comprises a central unit and at least one peripheral unit, characterized in that said—or each—peripheral unit consists of a detection unit 1 as described above.

Of course, the invention is not limited to the embodiments that are described and shown in the accompanying drawings. Modifications are possible, in particular from the standpoint of the composition of various elements or by substitution of equivalent techniques, without thereby exceeding the field of protection of the invention.

1) Detection unit that integrates at least one motion detector, a presence detector, a camera, or a combination of at least two such devices, in particular as a component of a security, alarm and/or surveillance system, whereby the functional elements of said unit are housed in a housing that is attached to a wall, a pole, a roof or the like, in particular by means of an attachment accessory, in particular of the articulated arm type or the like,
unit (1) that is characterized in that it also comprises:
A means (5) that can measure a variation of the absolute angle relative to the vertical line of a reference surface of the housing (2), a portion of the housing (2), at least one internal functional element, or a group of such internal functional elements (3), and that can deliver a measuring signal that can be exploited by the unit (1) and/or the system to which said unit (1) belongs,
A means for storing an angular reference position relative to the vertical line, for example acquired during the installation of the unit (1), and
A means for comparing the difference between the value that is measured by the means (5) and this reference value, with a threshold value for triggering the signaling to the system.

2) Unit according to claim 1, wherein the means
(5) that can measure a variation of the absolute angle relative to the vertical line comprises a measuring means of the inclinometer type that is associated with a reference surface that is part of the unit (1), the housing (2) or a functional element (3).

3) Unit according to claim 1, wherein the measuring means of the inclinometer type (5) is mounted on a part of the housing (2) or on a support of a group of functional elements (3), such as an electronic card, necessarily undergoing, in the event that the housing (2) is opened, a displacement or a movement that generates a modification of its angular orientation, in particular a movement of rotation or pivoting.

4) Unit according to claim 1, wherein the means of the inclinometer type (5) consists of an integrated circuit that integrates an electronic device for conditioning the signal that is delivered by a sensitive element in the form of a microsystem that is manufactured on silicon and consists of a capacitive comb that deforms under the action of gravity.

5) Unit according to claim 1, wherein the means of the inclinometer type (5) consists of an accelerometer with two axes, in particular of MEMS type.

6) Unit according to claim 5, wherein the inclinometer (5) of the accelerometer type with two axes provides a measuring signal with a continuous component that corresponds to the earth's gravity and an alternative component that makes it possible, when its value exceeds a preset threshold, to detect sudden vibrations and/or displacements of the reference surface associated with said inclinometer (5).

7) Unit according to claim 1, wherein it also comprises a sensor (6) that makes it possible to determine the orientation of the earth's magnetic field and is able to provide an indication on the orientation of a device for detection or guided visualization of said unit (1) or of the latter itself.

8) Unit according to claim 7, wherein the sensor (6) for determination of the orientation of the earth's magnetic field consists of a magnetoresistive sensor.

9) Unit according to claim 1, wherein it also comprises a means (7) for determination of the height of said unit (1) relative to the ground or to a reference surface, for example in the form of an ultrasonic sensor, a pressure sensor, or the like.

10) Unit according to claim 1, wherein the means of inclinometer type (5) is activated intermittently.

11) Unit according to claim 1, wherein it also comprises at least one means (9) that can measure a variation of capacity between at least two parts that form electrodes (10) or between at least one electrode-forming part (10) and a virtual or real mass of said unit (1), whereby said electrode(s) (10) is/are located on or inside the housing (2) by a mounting point that is protected from the unplanned or accidental approach of an object, element, body or the like that can influence or modify a charge or an electrical field, whereby said means (10) delivers a measuring signal, a passing signal or an incident signal that can be exploited by the unit (1) and/or by the system to which said unit (1) belongs and forms—in association with said at least one electrode (10)—a capacitive-type proximity detector.

12) Unit according to claim 11, wherein one of or said at least one electrode(s) (10) consists of a conductive part for assembly or for attachment of the protective housing (2), preferably a metal part, such as, for example, a screw or the like.

13) Unit according to claim 11, wherein said at least one electrode (10) is mounted at the level of a support or an analogous retractable deformation (11) of the protective housing (2), for example by being housed at the bottom of a deformation (11) in the form of a well of a constituent part (2′, 2″) of the protective housing (2).

14) Unit according to claim 11, wherein one of or said at least one electrode (10) is located at a mounting point in the protective housing (2) that is distant from the wall (12) of the latter, in particular wall portions that are accessible and apparent in the installed state of said unit (1).

15) Security, alarm and/or surveillance system that comprises a central unit, and at least one peripheral unit, wherein said or each peripheral unit consists of a detection unit (1) according to claim 1.

16) Unit according to claim 2, wherein the measuring means of the inclinometer type (5) is mounted on a part of the housing (2) or on a support of a group of functional elements (3), such as an electronic card, necessarily undergoing, in the event that the housing (2) is opened, a displacement or a movement that generates a modification of its angular orientation, in particular a movement of rotation or pivoting.

17) Unit according claim 12, wherein said at least one electrode (10) is mounted at the level of a support or an analogous retractable deformation (11) of the protective housing (2), for example by being housed at the bottom of a deformation (11) in the form of a well of a constituent part (2′, 2″) of the protective housing (2).

18) Unit according to claim 12, wherein one of or said at least one electrode (10) is located at a mounting point in the protective housing (2) that is distant from the wall (12) of the latter, in particular wall portions that are accessible and apparent in the installed state of said unit (1).
